(19) United States
(12) Patent Application Publication
(10) Pub. No.: US 2025/0003460 A1
(43) Pub. Date: Jan. 2, 2025

(54) CORDAGE TRAVERSING DEVICE

(71) Applicant: Atlas Devices LLC, Chelmsford, MA (US)

(72) Inventors: Nathan Ball, Forest Grove, OR (US); Daniel Walker, Melrose, MA (US); Gino Kahaunaele, Durham, NC (US)

(21) Appl. No.: 18/760,931

(22) Filed: Jul. 1, 2024

Related U.S. Application Data
(60) Provisional application No. 63/524,179, filed on Jun. 29, 2023.

(51) Int. Cl. F16D 63/00; B61B 7/06; F16D 121/14; F16D 125/64

(52) U.S. Cl. CPC F16D 63/008; B61B 7/06; F16D 2121/14; F16D 2125/64

(57) ABSTRACT

A cordage traversing device is structured to couple to a taut cordage and move along the taut cordage in a horizontal or vertical direction. The cordage traversing device has a chassis. The cordage traversing device has stationary sheaves coupled to the chassis and a movable sheave coupled to the chassis. The cordage traversing device has a tensioner structured to move the movable sheave between a locked position and an unlocked position.

### PRIORITY

This patent application claims priority from provisional U.S. patent application No. 63/524,179, filed Jun. 29, 2023, entitled, “METHOD TO ATTACH LINE TRAVERSING DEVICE TO TAUT LINE,” and naming Nathan Ball et al. as inventors, the disclosure of which is incorporated herein, in its entirety, by reference.

### FIELD

Illustrative embodiments of the invention generally relate to methods and devices for guiding the motion of personnel and equipment along taut cordages and, more particularly, various embodiments of the invention relate to bidirectional movement of a load along the taut cordage.

### BACKGROUND

For thousands of years, humans have utilized cordages, such as ropes and cables, to guide the movement of personnel and equipment in various applications. In tree work, for instance, loggers and arborists use diagonal taut cordages stretching from high points in trees to ground anchors to safely slide branches and trunk segments to the ground, away from the tree. Similarly, in maritime operations, taut cordages between ships facilitate the transfer of fueling hoses and cargo. In utility maintenance, taut cordages extending from high transmission towers to ground anchors or vehicles guide personnel and equipment being raised and lowered. Climbing and rescue operations often employ tensioned horizontal cordages, known as Tyrolean traverses, to allow people and equipment to cross ravines, rivers, and crevasses. While gravity can aid in the downward motion of loads along taut cordages, horizontal or upward motion necessitates manual force application.

### SUMMARY OF VARIOUS EMBODIMENTS

In accordance with one embodiment of the invention, the cordage traversing device includes a chassis. stationary sheaves and a movable sheave are coupled to the chassis. The cordage traversing device also has a tensioner to move the movable sheave between a locked position and an unlocked position.

The plurality of stationary sheaves and the movable sheave may form a straight cordage path when the movable sheave is in the unlocked position, and the plurality of stationary sheaves and the movable sheave form a zig-zag cordage path when the movable sheave is in the locked position.

The wrap angle of the plurality of stationary sheaves and a wrap angle of the movable sheave may increase in response to the tensioner moving the movable sheave toward the locked position. Wrap angles of the plurality of stationary sheaves and the movable sheave may be all less than 90 degrees.

The plurality of stationary sheaves and the movable sheave may simultaneously engage a cordage when the movable sheave is in the locked position.

In some embodiments, the tensioner includes at least one of a lever structured to move the movable sheave toward the locked position or a screw structured to move the movable sheave toward the locked position. In some embodiments, the tensioner includes a load attachment point and a pivot point coupled to the chassis.

In some embodiments, the cordage traversing device includes a motor to rotate a first stationary sheave of the plurality of stationary sheaves while the movable sheave is in a locked position.

The plurality of stationary sheaves and the movable sheave may be coupled to a same exterior side of the chassis. The stationary sheaves and the movable sheave may be oriented in the same direction and are coplanar.

In accordance with another embodiment, a method for traversing a taut cordage moves a movable sheave of a cordage traversing device to an unlocked position, the cordage traversing device including a plurality of stationary sheaves coupled to a chassis and a tensioner coupled to the movable sheave, the movable sheave being coupled to the chassis. The method positions a taut cordage between the stationary sheaves and the movable sheave. The method moves the movable sheave from the unlocked position toward the locked position. The method then zigzags the cordage using the stationary sheaves and the movable sheave.

The plurality of stationary sheaves may have a first stationary sheave and a second stationary sheave, and zigzagging the cordage includes applying a force to a midsection of the cordage between the first and second stationary sheave in response to moving the movable sheave toward the locked position.

The orientation of the taut cordage may include a vertical component, and wherein the method comprises moving the cordage traversing device upwardly while the movable sheave is in the locked position.

In some embodiments, the cordage traversing device has a motor coupled to the plurality of sheaves and the motor moves the cordage traversing device upward by rotating the plurality of sheaves.

The plurality of stationary sheaves and the movable sheave may form a straight cordage path when the movable sheave is in the unlocked position, and the plurality of stationary sheaves and the movable sheave may form a zig-zag cordage path when the movable sheave is in the locked position.

The wrap angle of the plurality of stationary sheaves and a wrap angle of the movable sheave may increase while moving the movable sheave from the unlocked position toward the locked position.

In some embodiments, the tensioner may have a lever structured to move the movable sheave toward the locked position or a screw structured to move the movable sheave toward the locked position.

The wrap angles of the plurality of stationary sheaves and the movable sheave, when in the locked position, may be less than 90 degrees.

The plurality of stationary sheaves and the movable sheave are coupled to the same exterior side of the chassis. The stationary sheaves and the movable sheave may be oriented in the same direction and are coplanar.

In some embodiments, the tensioner has a lever including a load attachment point and a pivot point coupled to the chassis, and moving the movable sheave from the unlocked position toward the locked position includes rotating the lever about the pivot point.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A is a front view schematically showing a cordage traversing device in an unlocked position in accordance with various embodiments.

FIG. 1B is a front view schematically showing the cordage traversing device in a locked position in accordance with various embodiments.

FIG. 2 is a side view schematically showing the cordage traversing device in accordance with various embodiments.

FIG. 3 is a front view schematically showing a cordage traversing device having a lever-based tensioner in accordance with various embodiments.

FIG. 4 is a flowchart showing a process for moving the cordage traversing device along a taut cordage in accordance with various embodiments.

### DESCRIPTION OF ILLUSTRATIVE EMBODIMENTS

In illustrative embodiments, a cordage traversing device has pulley sheaves coupled to a chassis. Some of the sheaves are stationary, while at least one sheave moves between a locked position and an unlocked position. In the locked position, a taut cordage may be positioned within a straight cordage path between the movable sheave and the stationary sheaves. In the locked position, the movable sheave pushes against the cordage, zigzagging the cordage and increasing the grip between the cordage and the cordage traversing device.

To provide controllable bi-directional motion in horizontal or upward directions along a taut cordage, the sheaves engaging with the cordage may be powered, either manually via hand crank or with a motor. For the sheaves to impart forces against the cordage that result in motion of the device along the cordage when the sheaves turn, sufficient grip must exist between the sheaves and the cordage. This grip may come from several interactions, including frictional forces between the sheave and the cordage, and direct mechanical engagement (i.e. localized clamping) such as would be provided by ridges on a sheave that penetrate some amount into the cordage when the cordage and ridges are pushed together by a force. This secure mounting of the cordage traversing device to the cordage via the sheaves enables motion of the chassis along the cordage such that a load attached to the device is moved with precision. Details of illustrative embodiments are discussed below.

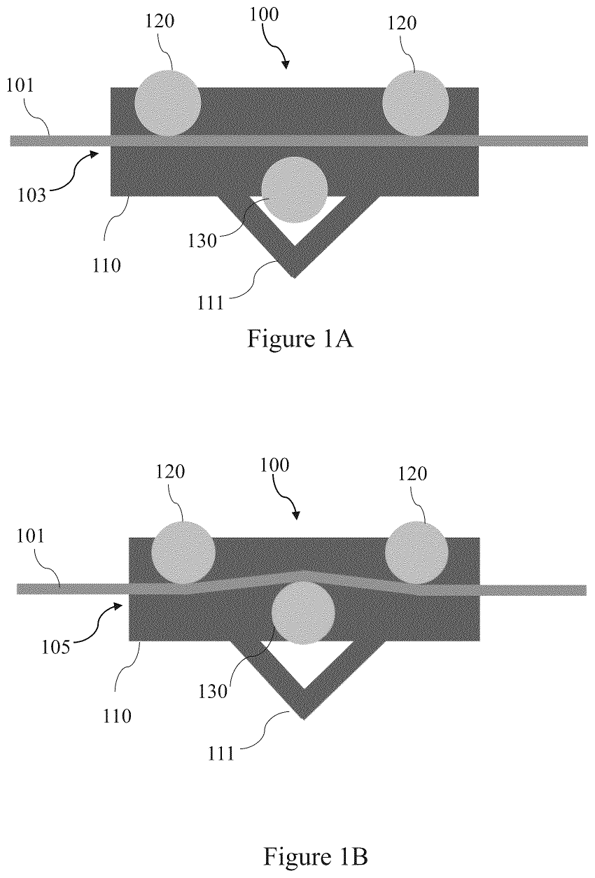

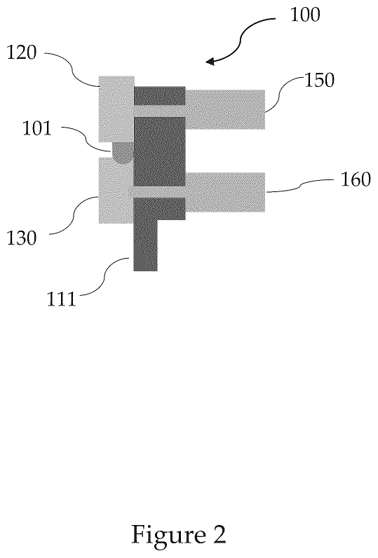

FIGS. 1A, 1B, and 2 schematically show a cordage traversing device 100 configured to move along a cordage 101 in both directions. The cordage 101 may be any type of cordage, including a rope, line, cord, twine, or cable, among other things. The cordage 101 is taut. In some embodiments, taut may mean the cordage 101 is stretched between two anchored points. Taut may additionally mean the cordage 101 has insufficient slack for a user to wrap the cordage 101 around a pulley sheave of the cordage traversing device 100 while the cordage 101 is stretched between the two anchor points. It should be appreciated that the cordage traversing device 100 may be implemented in a variety of applications, including logging, maritime operations, utility grid maintenance, search and rescue, construction, spelunking, elevator cables, and rock climbing, to name but a few examples.

The cordage traversing device 100 has a chassis 110 to structurally support the weight of a load coupled to the cordage traversing device 100, as well as to resist the forces applied to the cordage 101 by the cordage traversing device 100. In the illustrated embodiment, the chassis 110 includes a load attachment point 111 for coupling a load to the cordage traversing device 100. The load may be any item having weight. For example, the load may be one or more persons, animals, or inanimate objects, among other things. In some embodiments, the load attachment point 111 may be incorporated into another component of the cordage traversing device 100.

The cordage traversing device 100 has stationary pulley sheaves 120, also known as stationary sheaves, configured to grip the cordage 101, rotate about an axis, and bear the weight of the load. The stationary sheaves 120 are coupled to the chassis 110 on one exterior side, as illustrated in FIG. 2, allowing the cordage 101 to be positioned within the sheave by way of the open side. In some embodiments, each sheave is only coupled to the chassis 110 on one side, as in the illustrated embodiment. In the illustrated embodiment, the cordage traversing device 100 has two stationary sheaves 120, but the cordage traversing device 100 may have another number of stationary sheaves.

The cordage traversing device 100 has a movable sheave 130 configured to move between an unlocked position and a locked position. The movable sheave 130 is coupled to the chassis 110 using a sliding or pivoting mount, among other things. In the unlocked position, the movable sheave 130 is positioned far enough away from the stationary sheaves 120 to form a straight cordage path, allowing the taut cordage 101 to be placed between the stationary sheaves 120 and the movable sheave 130. In the locked position, the movable sheave 130 is pushed against the cordage 101, driving the cordage 101 into the sheaves, increasing the wrap angle of the cordage 101 around each of the sheaves, thus increasing the friction (i.e., grip) between the sheaves and the cordage 101. Moving the movable sheave 130 into the locked position also increases the force between the cordage 101 and the sheaves of the cordage traversing device 100, thus increasing friction. In some embodiments, the cordage traversing device 100 may include more than one movable sheave 130.

In some embodiments, the movable sheave 130 is moved directly toward a the stationary sheave 120, clamping the cordage 101 between the two sheaves. In the illustrated embodiment, the movable sheave 130 is positioned between two stationary sheaves 120. In other embodiments, the movable sheave 130 may be positioned differently, such as on an end, among other things.

The interfaces between the cordage 101 and the sheaves of the cordage traversing device 100 have friction. The ability for the sheaves 120, 130 to apply forces to the taut cordage 101 that result in the chassis 110 moving along the cordage 101, especially in a horizontal or upward direction, depends on the grip between the sheaves 120, 130 and the cordage 101. This grip can be accomplished via friction in conjunction with the normal force resulting from the cordage tension. In some embodiments, the grip may be increased by a physical direct engagement between the sheave and the cordage 101. For example, one or more sheaves may have radial grooves or ridges that penetrate some distance into the cordage 101 when under force. Various treatments (i.e., coatings or knurling among other things), and features (i.e., rope grab tracks, rubber belts, slack grabber tracks/belts, carbide spikes, or anisotropic features, among other things) may be applied to or included on the wheels that enable them to ideally grip the cordage 101.

In some embodiments, the sheaves 120, 130 include a profile to increase the grip. V-groove pulleys add additional useful frictional forces even with a smooth inner surface by wedging the cordage 101 deep into the groove. Other sheave modifications such as the addition of grooves or ridges positioned around or along the various surfaces of the wheel that are contacted by the cordage 101 may add additional force-imparting capabilities within a given range of available cordage tensions that may be encountered. For instance, radially oriented ridges on the inner surfaces of a V-pulley may offer a dramatic improvement in the grip of the sheave on the cordage 101.

The cordage traversing device 100 includes a tensioner 150 to apply a force to the movable sheave 130 effective to move the movable sheave 130 between the unlocked and locked positions while applying and holding the resulting normal forces. The force to apply may be a function of cordage elasticity, cordage tension, and cordage/sheave interface friction coefficient, among other things, In some embodiments, the tensioner 150 may the movable sheave 130 coupled to a pivoting over-center latch bar, such that increased forces that would push the movable sheave 130 away increase the force holding the over-center latch bar the movable sheave 130 is mounted to in its second position, or mounting the movable sheave 130 wheel movably by a sliding or pivoting mount that can manually be moved with forces applied by some other typical means, such as a threaded screw tightening mechanism, cam, spring, linkage, latch, motor, hydraulics, magnets, or actuator, among other things.

In the illustrated embodiment, the cordage traversing device 100 includes a motor 160 to rotate one of the sheaves of the cordage traversing device 100, effective to move the cordage traversing device 100 along the taut cordage 101. In some embodiments, the cordage traversing device instead includes a hand crank, or another means of rotating one of the sheaves to propel the cordage traversing device 100 along the cordage 101. In some embodiments, the motor 160 includes a gearbox to adjust the rotational speed of an output shaft of the motor 160. The motor 160 may include a device to prevent over torque, such as a slip clutch, among other things. In some embodiment, the motor 160 includes a remote release to isolate the motor 160 from the connectable sheave to allow the cordage traversing device 100 to be pulled along the cordage 100 without damage to the motor 160. The remote release may be mechanical (e.g. secondary string pulls release lever) or electrical (e.g. solenoid is remotely activated and pulls release lever).

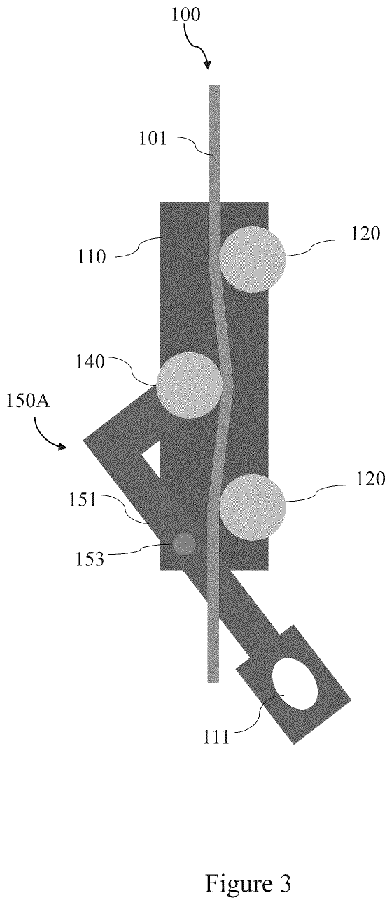

FIG. 3 schematically shows the cordage traversing device 100 having a lever-based tensioner 150A. The tensioner 150A has a bar 151 coupled to the movable sheave and also coupled to the chassis 110 by way of a pivot point 153. The bar 151 rotates about the pivot point 153 when a force is applied to the bar 151. The tensioner 150A includes the load attachment point on one end of the bar. In the illustrated embodiment, the pivot point 153 is located in the approximate middle of the bar 151. In other embodiments, the pivot point 153 may be located closer to either end of the bar 151 to adjust the lever ratio and thus the force applied to the movable sheave 130 by a load.

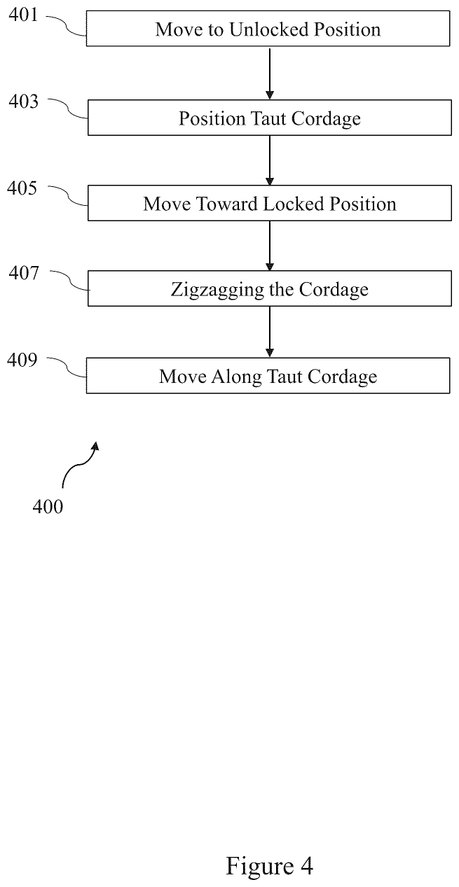

FIG. 4 shows an exemplary process 400 for traversing a taut cordage in accordance with the illustrative embodiment. The Process 400 may be implemented in whole or in part in one or more of the cordage traversing devices 100 disclosed herein. It shall be further appreciated that a number of variations and modifications to the Process 400 is contemplated including, for example, the omission of one or more aspects of the Process 400, the addition of further conditionals and operations, or the reorganization or separation of operations and conditionals into separate processes.

The Process 400 begins by moving the movable sheave 130 to the unlocked position in operation 401. By moving the movable sheave away from the stationary sheaves 120, the straight cordage path 103 forms, allowing the taut cordage 101 to be placed between the stationary sheaves and the movable sheave 130.

The Process 400 then positions the taut cordage 101 into the cordage traversing device 100 between the stationary sheaves 120 and the movable sheave 130 in operation 403. Since the movable sheave 130 is in the unlocked position, the taut cordage 101 does not need to be bent or forced between the sheaves. In some embodiments, the stationary sheaves 120 bear the weight of the cordage traversing device 100 and load on the cordage 101.

While the cordage 101 is between the stationary sheaves and the movable sheave 130, The Process 400 moves the movable sheave 130 toward the locked position in operation 405. In some embodiments, a user may operate or activate the tensioner 150 to move the movable sheave 130 toward the locked position. As the movable sheave 130 is moved toward the locked position, the movable sheave 130 begins to exert a force on the cordage 101. As illustrated in FIG. 1B, the movable sheave 130 may apply a force to the section of cordage 101 between two stationary sheaves 120.

As the movable sheave 130 is moved toward the locked position, the force exerted on the cordage 101 zigzags the cordage 101 around the sheaves, forming the zigzag cordage path 105. A zigzag pattern may include a series of curves of the cordage 101 in alternating directions formed by the sheaves acting on the cordage 101. The zigzagging increases the length of the circumferences each sheave contacts the cordages 101, thus increasing the friction between the cordage 101 and the cordage traversing device 100. Because the cordage 101 is taut, the cordage 101 does not wrap around the pulley completely. In some embodiments, the wrap angle for each sheave is less than 180. In another embodiment, the wrap angle for each sheave while the movable sheave 130 is in the locked position is less than 90 degrees.

After the movable sheave 130 is in the locked position, the Process 400 may then proceed to operation 409, where the cordage traversing device 100 moves along the taut cordage 101. The additional grip allows the cordage traversing device 100 to move in any direction, including upwardly or horizontally. In some embodiments, the cordage traversing device 100 moves along the cordage 101 using the motor 160 by rotating one of the sheaves.

It is contemplated that the various aspects, features, processes, and operations from the various embodiments may be used in any of the other embodiments unless expressly stated to the contrary.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A cordage traversing device comprising:
a chassis;
a plurality of stationary sheaves coupled to the chassis;
a movable sheave coupled to the chassis; and
a tensioner structured to move the movable sheave between a locked position and an unlocked position.

2. The cordage traversing device of claim 1, wherein the plurality of stationary sheaves and the movable sheave form a straight cordage path when the movable sheave is in the unlocked position, and
wherein the plurality of stationary sheaves and the movable sheave form a zig-zag cordage path when the movable sheave is in the locked position.

3. The cordage traversing device of claim 1, wherein a wrap angle of the plurality of stationary sheaves and a wrap angle of the movable sheave increase in response to the tensioner moving the movable sheave toward the locked position.

4. The cordage traversing device of claim 1, wherein the plurality of stationary sheaves and the movable sheave are structured to simultaneously engage a cordage when the movable sheave is in the locked position.

5. The cordage traversing device of claim 1, wherein the tensioner includes at least one of a lever structured to move the movable sheave toward the locked position or a screw structured to move the movable sheave toward the locked position.

6. The cordage traversing device of claim 1, wherein wrap angles of the plurality of stationary sheaves and the movable sheave are all less than 90 degrees.

7. The cordage traversing device of claim 1, comprising a motor structured to rotate a first stationary sheave of the plurality of stationary sheaves while the movable sheave is in the locked position.

8. The cordage traversing device of claim 1, wherein the plurality of stationary sheaves and the movable sheave are coupled to a same exterior side of the chassis.

9. The cordage traversing device of claim 8, wherein the stationary sheaves and the movable sheave are oriented in a same direction and are coplanar.

10. The cordage traversing device of claim 1, wherein the tensioner includes a load attachment point and a pivot point coupled to the chassis.

11. A method for traversing a taut cordage, comprising:
moving a movable sheave of a cordage traversing device to an unlocked position, the cordage traversing device including a plurality of stationary sheaves coupled to a chassis and a tensioner coupled to the movable sheave, the movable sheave being coupled to the chassis;
positioning a taut cordage between the stationary sheaves and the movable sheave;
moving the movable sheave from the unlocked position toward a locked position; and
zigzagging the cordage using the stationary sheaves and the movable sheave.

12. The method of claim 11, wherein the plurality of stationary sheaves includes a first stationary sheave and a second stationary sheave, and wherein zigzagging the cordage includes applying a force to a midsection of the cordage between the first and second stationary sheave in response to moving the movable sheave toward the locked position.

13. The method of claim 11, wherein an orientation of the taut cordage includes a vertical component, and wherein the method comprises moving the cordage traversing device upwardly while the movable sheave is in the locked position.

14. The method of claim 13, wherein the cordage traversing device includes a motor coupled to the plurality of stationary sheaves, and wherein the motor moves the cordage traversing device upward by rotating the plurality of stationary sheaves.

15. The method of claim 11, wherein the plurality of stationary sheaves and the movable sheave form a straight cordage path when the movable sheave is in the unlocked position, and
wherein the plurality of stationary sheaves and the movable sheave form a zig-zag cordage path when the movable sheave is in the locked position.

16. The method of claim 11, wherein a wrap angle of the plurality of stationary sheaves and a wrap angle of the movable sheave increase while moving the movable sheave from the unlocked position toward the locked position.

17. The method of claim 11, wherein the tensioner includes at least one of a lever structured to move the movable sheave toward the locked position or a screw structured to move the movable sheave toward the locked position.

18. The method of claim 11, wherein wrap angles of the plurality of stationary sheaves and the movable sheave, when in the locked position, are all less than 90 degrees.

19. The method of claim 11, wherein the plurality of stationary sheaves and the movable sheave are coupled to a same exterior side of the chassis, and wherein the stationary sheaves and the movable sheave are oriented in a same direction and are coplanar.

20. The method of claim 11, wherein the tensioner includes a lever including a load attachment point and a pivot point coupled to the chassis, and wherein moving the movable sheave from the unlocked position toward the locked position includes rotating the lever about the pivot point.
